(19) United States
(12) Patent Application Publication
(10) Pub. No.: US 2015/0135332 A1
(43) Pub. Date: May 14, 2015

(54) Deferred Delivery of Electronic Signature Agreements

(71) Applicant: Adobe Systems Incorporated, San Jose, CA (US)

(72) Inventors: Benjamin D. Follis, Redwood City, CA (US); Paul J. Picazo, Mountain View, CA (US)

(73) Assignee: Adobe Systems Incorporated, San Jose, CA (US)

(21) Appl. No.: 14/076,988

(22) Filed: Nov. 11, 2013

(51) Int. Cl. G06F 21/62

(52) U.S. Cl. CPC G06F 21/62
USPC 726/28

(57) ABSTRACT

Techniques for deferred delivery of electronic signature agreements are described. In one or more embodiments, a request is received for a user of a client device to provide an electronic signature on a document. Access to the document by the user of the client device is delayed until a predefined time. The document can be communicated to the client device at or before the predefined time. Additionally, the user of the client device is allowed to provide the electronic signature on the document at or after the predefined time.

### BACKGROUND

Computers provide users with an ability to electronically sign documents to indicate that the users adopt the intentions recorded in the document. In one example, the users can form a contract with specific terms and conditions that each user agrees to by signing the contract. However, traditional techniques that were employed to enable electronic signing of documents may be inefficient for some time-sensitive situations.

### SUMMARY

Techniques for deferred delivery of electronic signature agreements are described. In one or more embodiments, a request is received for a user of a client device to provide an electronic signature on a document. Access to the document by the user of the client device is delayed until a predefined time. The document can be communicated to the client device at or before the predefined time. Additionally, the user of the client device is allowed to provide the electronic signature on the document at or after the predefined time.

In implementations, the document can be a contract between the user and one or more additional users. The document may also be an agreement between multiple parties, where the parties may be made aware of the existence of the agreement and the parties to the agreement, but may be prevented from electronically signing the agreement until a predefined time. In some implementations, one entity may be prevented from electronically signing a document until another entity first electronically signs the document. The parties to the agreement may have a corresponding time interval in which they may review and electronically sign the document. In at least one implementation, the document may be scheduled to be communicated to multiple client devices at a same uniform local time of each of the client devices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques for deferred delivery of electronic signature agreements.

FIG. 2 is a flow diagram depicting a procedure in an example implementation in which techniques for deferred delivery of electronic signature agreements are employed.

FIG. 3 is a flow diagram depicting a procedure in an example implementation in which techniques for deferred delivery of electronic signature agreements are employed in more detail.

FIG. 4 is a flow diagram depicting a procedure in an example implementation in which different time intervals are utilized for delivering a document and allowing an electronic signature on the document.

FIG. 5 is a flow diagram depicting a procedure in an example implementation in which multiple electronic signatures on a document are requested.

FIG. 6 is a flow diagram depicting a procedure in an example implementation in which a delay is implemented between signatures of entities on a document.

FIG. 7 is a flow diagram depicting a procedure in an example implementation in which deferred delivery of electronically signed agreements are employed for multiple independent documents.

FIG. 8 illustrates various components of an example device that can be implemented as any type of computing device as described with reference to FIG. 1 to implement embodiments of the techniques described herein.

### DETAILED DESCRIPTION

Overview

Conventional techniques that were used to enable electronic signing of documents may be inefficient in some time-sensitive situations. For example, a document, such as a contract, may need to be distributed on or after a specific date such that the contract corresponds to a product launch date, or a contract may be dependent on particular terms that expire at a specified date. In some cases, a signer may prematurely sign the contract, or might miss or misread a time constraint embedded in the “fine print” of the contract. For example, if a signer inadvertently misses a cutoff date, the contract may be adversely affected.

Techniques involving deferred delivery of electronic signature agreements are described. In the following discussion, a variety of different implementations are described that involve delaying delivery of a document for electronic signature and/or allowing access to the document for electronically signing the document. These implementations can delay signing and/or sending of the document until a certain time specified by a sender of the document. In addition, particular durations or windows of time can be specified in which the document is allowed to be electronically signed. Other example implementations include specifying intervals between signatures of different users, allowing time zone synchronization, or rate limiting of boilerplate agreements.

As employed herein, the term “sender” may refer to an entity that creates and/or sends a document to be signed by one or more users. The sender may be a user or other entity. Further, the sender may also provide an electronic signature on the document, or the sender may simply facilitate distribution of the document. As employed herein, the term “signer” may refer to an entity, such as a user, that provides an electronic signature on the document sent by the sender. The signer may sign the electronic signature to signify that the signer adopts or assents to the terms of the document.

As employed herein, a “document” may define a record of information, such a written account of ownership or obligation. The document may include a contract or other record usable to form an agreement between two or more persons. Further, the document can include an electronic document that is electronically signable by a signer, or that can be associated with an electronic signature. In embodiments, the document can be sent by the sender via a signature service to the signer. Additionally, the document may come into existence at a time of delivery to the signer. For example, metadata and content associated with the document, but not the document itself, may be created prior to delivery to the signer. However, the document may be created only upon the delivery to the signer. An electronic document can be created in a variety of formats, such as “.pdf”, “.txt”, “.doc”, “.docx”, “.html”, “.gif”, “.jpg”, and so on. Thus, a document can include a variety of different mediums via which to provide information that a user may adopt by electronically signing the document.

As will be discussed in greater detail below, a signature service may include an online service (e.g., web-based document service) that maintains information about senders, signers, documents, electronic signatures, and so on, to legally enforce signed documents. One example of a signature service is Adobe Echosign™.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

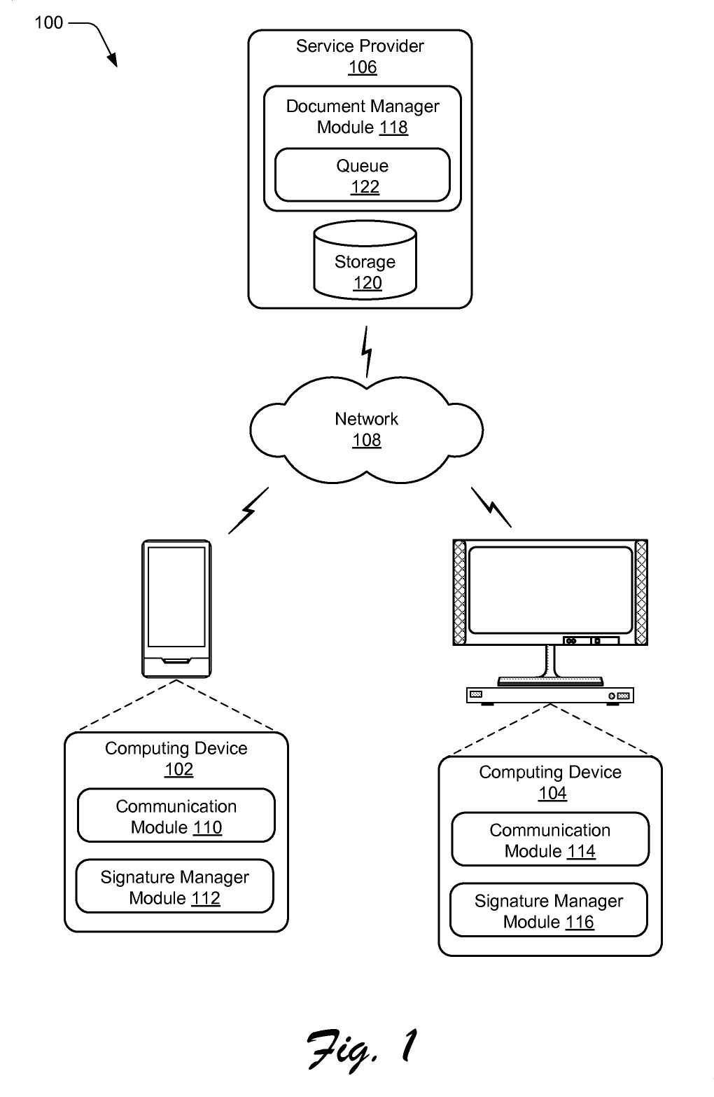

FIG. 1 is an illustration of an environment 100 in an example implementation that is operable to employ techniques described herein. The illustrated environment 100 includes computing devices 102, 104, and service provider 106 that are communicatively coupled via a network 108. In addition, the computing devices 102, 104 as well as computing devices that implement the service providers 106 may be configured in a variety of ways.

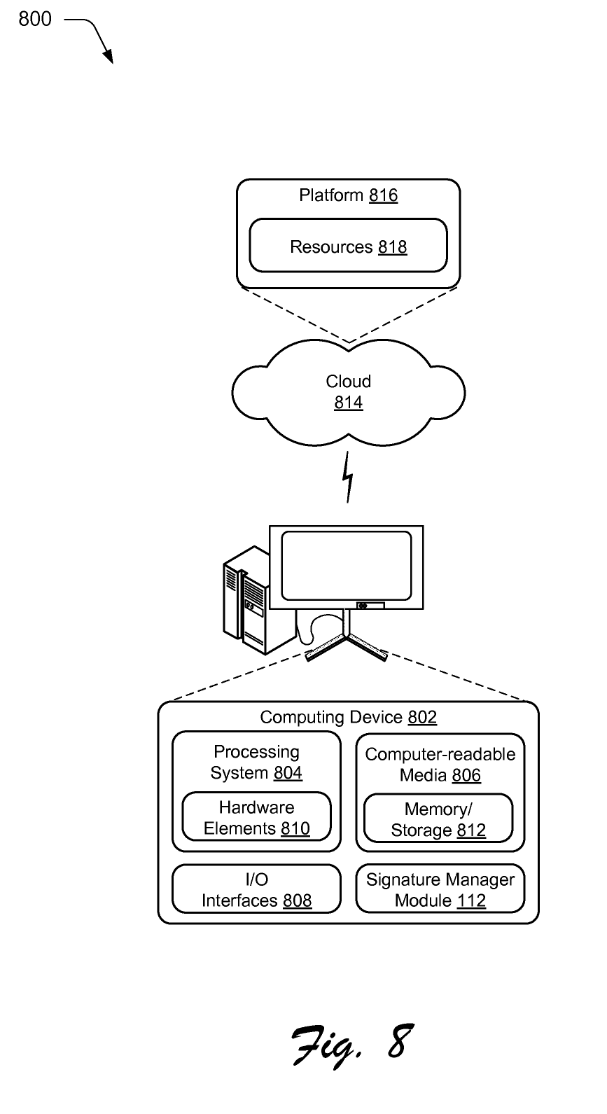

The computing devices, for example, may be configured as a desktop computer, a laptop computer, a mobile device (e.g., assuming a handheld configuration such as a tablet or mobile phone), and so forth. Thus, the computing devices may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers of the service provider 106 utilized by a business to perform operations “over the cloud” as further described in relation to FIG. 8, a tablet and a peripheral device, and so on.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be representative of multiple networks.

The computing device 102 is also illustrated as including a communication module 110 and a signature manager module 112. Similarly, the computing device 104 is illustrated as including a communication module 114 and signature manager module 116. The communication modules 110, 114 are representative of functionality to communicate via the network 108, such as with one or more services of the service provider 106. As such, the communication modules 110, 114 may be configured in a variety of ways. For example, one or more of the communication modules 110, 114 may be configured as a browser that is configured to “surf the web.” One or more of the communication modules 110, 114 may also be representative of network access functionality that may be incorporated as part of an application, e.g., to provide network-based functionality as part of the application, an operating system, and so on. Thus, functionality represented by the communication modules 110, 114 may be incorporated by the computing devices 102, 104 in a variety of different ways.

The signature manager modules 112, 116 are representative of functionality to electronically sign a document on the computing devices 102, 104, respectively. As such, the signature manager modules 112, 116 may be configured in a variety of ways. For example, one or more of the signature manager modules 112, 116 may be configured to provide a means for a user to indicate that the user adopts the contents of the document. The user's electronic signature, or e-signature, may include an electronic sound, symbol, or process attached to or logically associated with a document, contract, or other record and executed or adopted by a person with the intent to sign the record. In addition, the electronic signature can include one or more letters, characters, numbers or other symbols in a digital form incorporated in, attached to, or associated with the document.

The service provider 106 is representative of functionality of the service provider 106 to provide one or more network-based services. The services include an electronic signature service that is managed by a document manager module 118 to support a variety of different functionality. The signature services (e.g., web-based document services), for instance, may be configured to support functionalities such as creating documents, accessing and viewing documents, electronically signing documents, and so on. Thus, a variety of different types of actions may be performed with respect to documents managed by the services.

In at least one implementation, the document manager module 118 can receive a request for one or more users to electronically sign a document after a certain time. For instance, assume that a user (e.g., “sender”) creates a document, such as a contract, to be signed by one or more other users (e.g., “signers”) with certain time constraints. Using conventional techniques, the signers may prematurely sign the document, or might miss or misread a time constraint embedded in the “fine print” of the document. If one of the signers inadvertently misses a cutoff date, the contract may be adversely affected. However, using techniques described herein, the sender may specify a time delay or time interval during or after which the document may be signed by the signers. The document manager module 118 may maintain the document in storage 120 of the service provider 106, and queue the document for access by, or delivery to, the signers at, during, or after the time specified by the sender of the document. Thus, the document manager module 118 may provide the sender of the document more control over when the document is allowed to be accessed and/or signed by the signers, further discussion of which is described below.

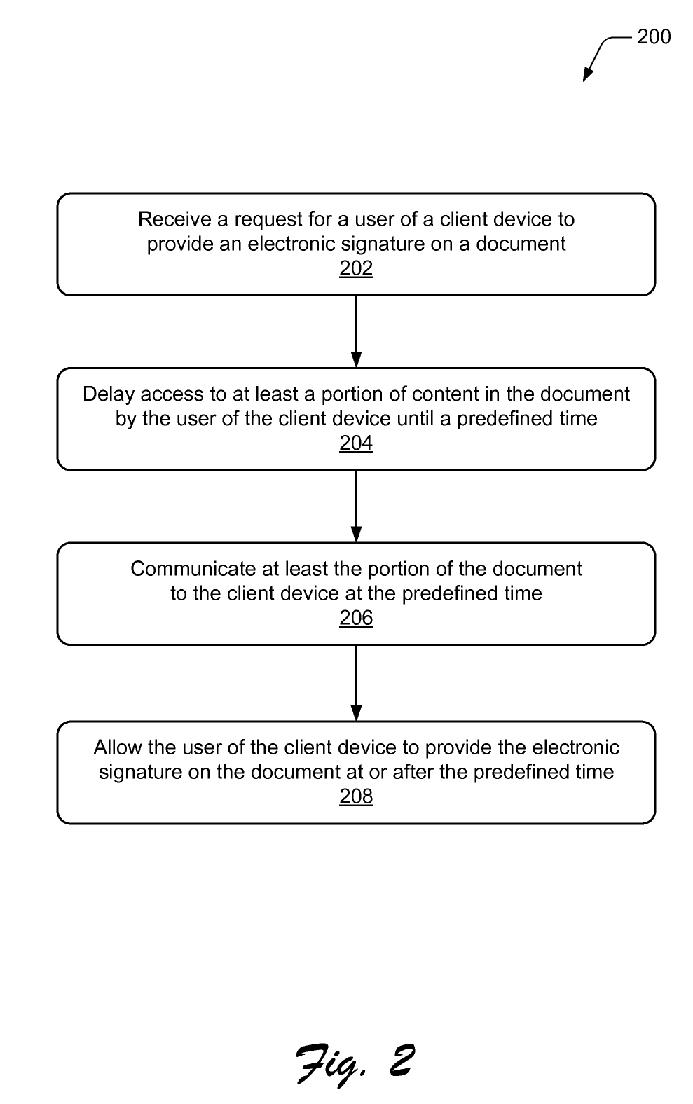

The queue 122 is representative of a data structure in which documents or indicators of documents can be maintained in association with indications of predefined times and/or dates. Any suitable queue can be utilized. For instance, the queue 122 can include an indication of a predefined time and/or date that specifies when a particular document is to be made accessible to signers and/or electronically signable by the signers. In at least one embodiment, the queue 122 can include an indication of a time interval during which the signers are allowed to electronically sign the document. Other time intervals may be specified to implement a delay between when a user can access the document and when the user can electronically sign the document. Further discussion of the queue 122 and the use of predefined times or dates is provided below with respect to FIGS. 2-8.

Example Procedures

The following discussion describes techniques for deferred delivery of electronic signature agreements that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. Further, although various different procedures are described herein, a combination of the described procedures may be employed to implement techniques for deferred delivery of electronic signature agreements. In portions of the following discussion, reference will be made to the environment 100 of FIG. 1.

FIG. 2 is a flow diagram depicting a procedure 200 in an example implementation in which techniques for deferred delivery of electronic signature agreements are employed. A request is received for a user of a client device to provide an electronic signature on a document (block 202). For example, the request can be received at the service provider 106 of FIG. 1 using the document manager module 118, and can be received from computing device 102 or another entity. In one implementation, a user of computing device 102 may have provided the document to the service provider 106 with a request for a user of computing device 104 to provide an electronic signature on the document.

Access to at least a portion of content in the document by the user of the client device is delayed until a predefined time (block 204). For example, the document manager module 118 may restrict access by the user of the client device to content in the document, or to the document itself, until the predefined time has elapsed, such as 11:00 am EST on Friday the 13^{th} of Dec., 2013. In one implementation, the request may specify a predefined time at or after which the user of the client device may be authorized to access or sign the document. However, the user of the client device may not be authorized to view and/or sign the document before the predefined time. The predefined time can be defined by a sender of the request, and can include any time in a particular time zone, any time in coordinated universal time (UTC), any calendar date, or any combination thereof.

Additionally, the predefined time may be adjustable. For example, the sender may communicate a request to the service provider 106 to adjust the predefined time prior to the predefined time elapsing. In at least one embodiment, the predefined time may be adjusted based on the occurrence of one or more events. By way of example and not limitation, an event may include receipt of an electronic signature on a related document, a change to daylight savings time, a change to one or more parties to an agreement, a change to content in the agreement, occurrence of the predefined time on a holiday or weekend, and so on. Thus, a variety of different events may occur that can trigger an adjustment to the predefined time.

The document, or a portion of the document, is communicated to the client device at the predefined time (block 206). This step can be performed in any suitable way. For example, the document or a portion of the document may be transmitted to the client device via the network 108 of FIG. 1. In another implementation, the client device may execute an application that, at the predefined time, is given authorization to display the document. In at least one embodiment, a notification of the document requiring an electronic signature may have been previously sent to the client device, and at the predefined time, the contents of the document may be communicated for display at the client device. In another example, the document, or a portion of the document, may be communicated to the client device before the predefined time. In this way, time may be provided to the client device to resolve any potential problems with the communication of the document or the portion of the document before the predefined time elapses.

The user of the client device is allowed to provide the electronic signature on the document at or after the predefined time (block 208). This step can be performed in any suitable way. For example, at the predefined time, the document manager module 118 may communicate a notification, such as an authorization code, to the client device to provide a means for which the user of the client device can enter an electronic signature to be associated with the document. In at least one embodiment, the user can be authorized to electronically sign the document at the predefined time. Alternatively, the user may only be authorized to sign the document at some point in time after the predefined time, such that the user may be able to view the document prior to being able to sign the document.

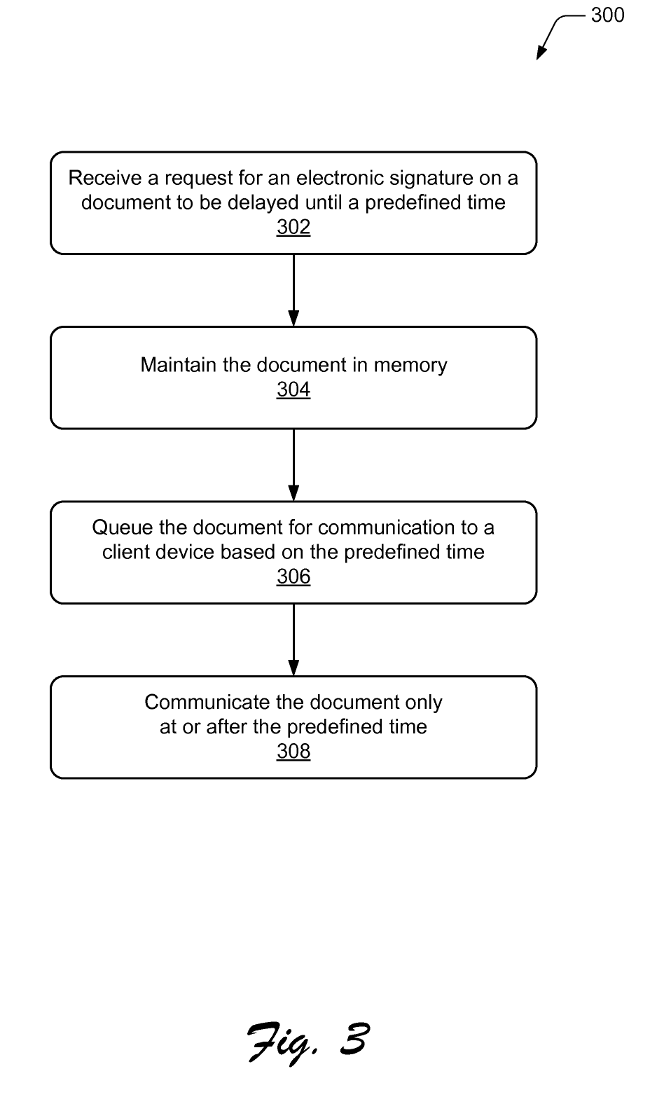

Consider now FIG. 3, which is a flow diagram depicting a procedure 300 in an example implementation in which techniques for deferred delivery of electronic signature agreements are employed in more detail. A request is received for an electronic signature on a document to be delayed until a predefined time (block 302). For example, the document manager module 118 of FIG. 1 may be configured to prevent recording of the electronic signature until the predefined time has elapsed. The document is maintained in memory (block 304). For example, prior to expiration of the predefined time, the document can be stored in a database or memory at the service provider 106, such as in storage 120.

The document is queued for communication to a client device based on the predefined time (block 306). In at least one embodiment, the document manager module 118 may utilize the queue 122 at the service provider 106 to queue the document for future delivery to the client device. Then, the document is communicated only at or after the predefined time (block 308). For instance, once the predefined time has elapsed, the document manager module 118 can be notified that the document associated with the predefined time in the queue 122 can now be communicated to intended recipients, such as the client device identified in the queue 122.

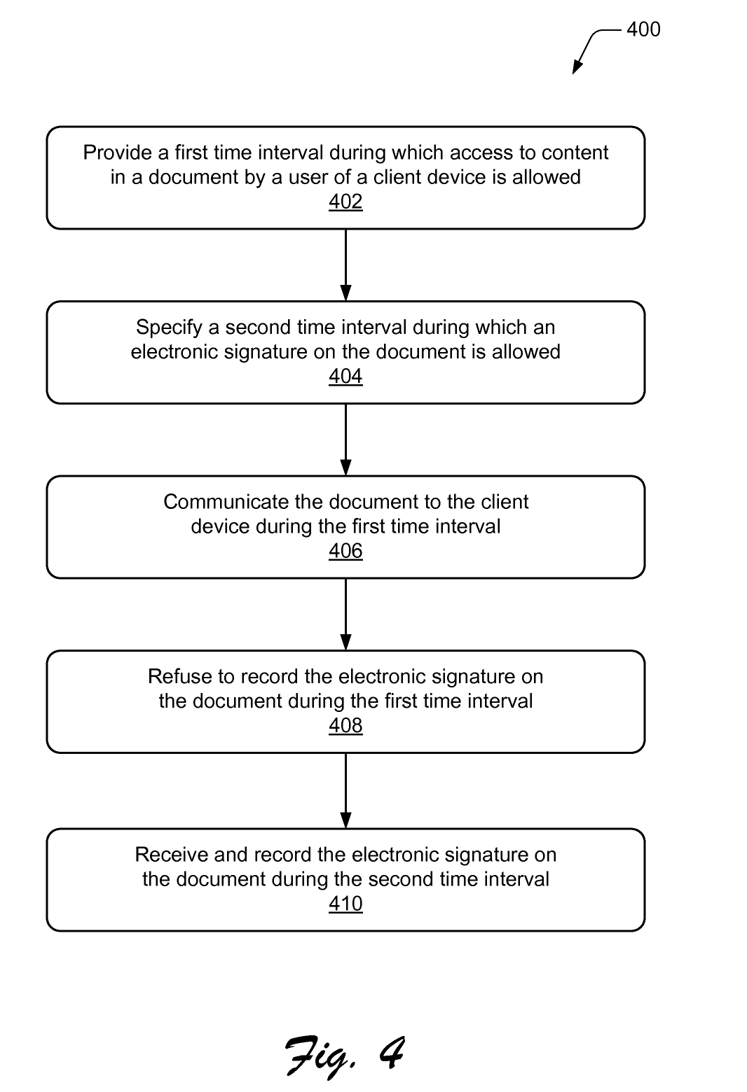

Consider now FIG. 4, which is a flow diagram depicting a procedure 400 in an example implementation in which different time intervals are utilized for delivering a document and allowing an electronic signature on the document. A first time interval is provided during which access to content in a document by a user of a client device is allowed (block 402). In some embodiments, the first time interval may define a limited duration of time in which access is granted to the user. Prior to, and subsequent to, the first time interval, the user may be unauthorized to access the content in the document.

A second time interval is specified during which an electronic signature on the document is allowed (block 404). The second time interval may overlap in time with the first time interval, or may be a separate and unique duration of time that does not overlap with the first time interval. In at least one embodiment, the user may be provided with an option to electronically sign the document during the second time interval, but may be denied the option to electronically sign the document outside of the second time interval. In some implementations, the user may only be allowed to electronically sign the document after sufficient time has elapsed (e.g., the first time interval). In this way, the user may be prevented from signing the document before having sufficient time to first review the contents of the document.

In one example, the document may include an agreement for purchase of a product or service at a discounted price during a limited-time promotion. To encourage a consumer to enter into the agreement associated with the limited-time promotion, the user may be provided with a specified duration of time in which to electronically sign the agreement, else the promotion may end and the opportunity for a discounted purchase price may pass.

In another example, multiple signers may each be given a time interval, such as a week or certain number of days, hours, minutes, or any combination thereof, in which to access and/or sign the document. One signer's time interval may overlap with another signer's time interval, or there may be no overlap in time intervals of the signers. Alternatively or in addition, the various time intervals for the signers may be different durations of time, or the various time intervals may be substantially equal. Thus, a variety of different configurations of time intervals are contemplated.

The document is communicated to the client device during the first time interval (block 406). This step can be performed in any suitable way, examples of which are discussed above. The electronic signature is refused recording on the document during the first time interval (block 408). For example, assume a user attempts to electronically sign the document shortly after accessing the document, such that insufficient time has elapsed for an average person to read the contents of the document. In this example, it can be assumed that the user has not had sufficient time to review the contents of the document prior to adopting such contents with an electronic signature. Thus, the user can be prevented from adopting an agreement having content of which the user is potentially unaware.

The electronic signature is received and recorded on the document during the second time interval (block 410). This step can be performed in any suitable way. For example, during the second time interval, the user of the client device may be authorized to provide the electronic signature. The document manager module 118 may receive the electronic signature from the client device and record the electronic signature on the document. In one example, the electronic signature may be recorded on the document by associating the electronic signature with the document and storing the document and associated electronic signature in storage 120.

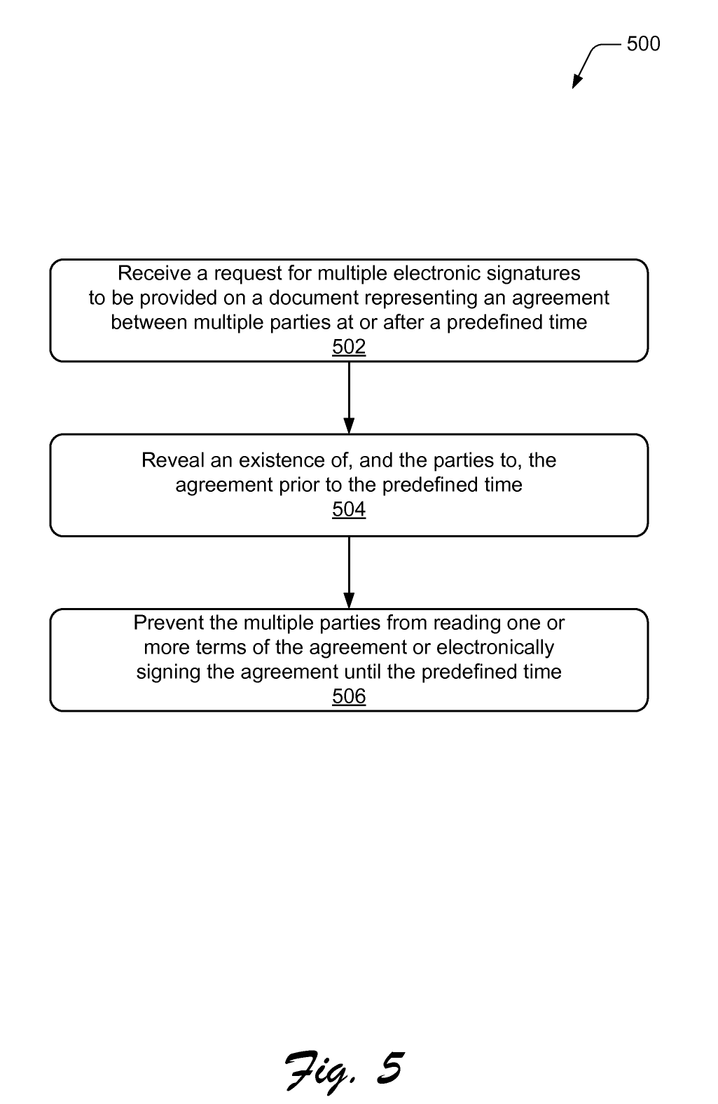

FIG. 5 is a flow diagram depicting a procedure 500 in an example implementation in which multiple electronic signatures on a document are requested. A request is received for multiple electronic signatures to be provided on a document representing an agreement between multiple parties at or after a predefined time (block 502). For example, the request may specify a predefined time at which the electronic signatures are allowed to be received and/or associated with the document. The existence of, and the parties to, the agreement are revealed prior to the predefined time (block 504). For example, a notification may be communicated to the parties to indicate that the agreement is to be established at or after the predefined time. The parties may therefore be notified that the agreement exists and provided with an indication of who may be a party to the agreement.

The multiple parties are prevented from reading one or more terms of the agreement or electronically signing the agreement until the predefined time (block 506). In at least one embodiment, the multiple parties may be notified that the agreement is being established, but any one or more of the parties may be prevented from learning the terms of the contract before another party. Using conventional techniques, each of the parties may be given access to an agreement, but in some cases at least one of the parties might not be able to view the document until a later time due to scheduling conflicts. Using the techniques described herein, the parties privy to the agreement may, based on the notification, prepare for the predefined time at which the terms of the agreement may be accessible for review. For example, the parties may be notified that the agreement may be accessible at a certain time of day, such as 12:00 pm EST. In this way, all of the parties privy to the agreement may have substantially equal opportunity to access and review the terms of the agreement.

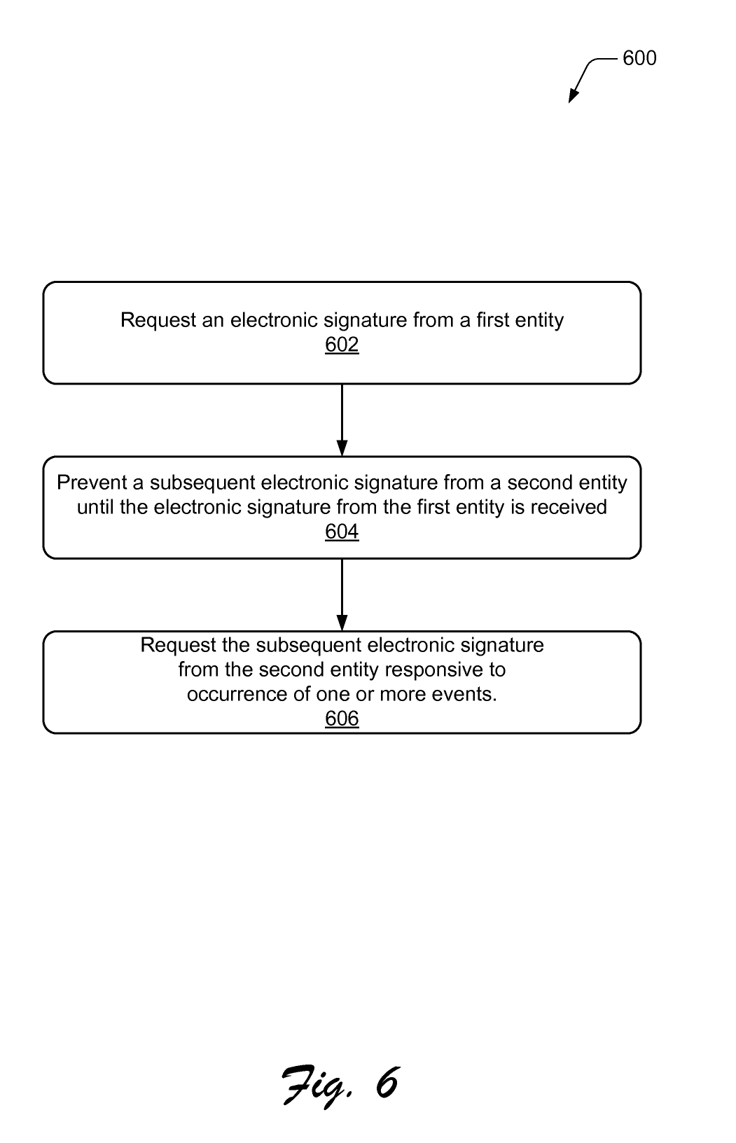

FIG. 6 is a flow diagram depicting a procedure 600 in an example implementation in which a delay is implemented between signatures of entities on a document. An electronic signature is requested from a first entity (block 602). This step can be performed in any suitable way, as described above. A subsequent electronic signature from a second entity is prevented until the electronic signature from the first entity is received (block 604). In at least some embodiments, a sender of a document requesting electronic signatures may define a fixed delay between when a signer signs the document and when subsequent signers receive and/or gain access to the document. For example, it may be desirable to prevent a competitor from gaining knowledge of an agreement until a preceding signer has had an opportunity to take actions specified by the agreement.

Alternatively or in addition, the sender may specify in the request a delay between when a next signature is allowed. For example, the delay may prevent an entity from signing the document before another entity signs the document. In some instances, failure of one entity to sign the document may terminate an agreement associated with the document, prevent the document from being communicated to subsequent signers, and/or cause subsequent signatures to no longer be requested. Another example may include an attempt to avoid a certain entity becoming a party to the agreement.

In some embodiments, a sender may have two or more contracts pending. For example, assume that the contracts have each been communicated to at least one signer, and the sender is waiting for a response from the signers. Completion of electronic signatures for one of the contracts may trigger a stop to another of the contracts. In at least one embodiment, respective durations of time for signing the contract may be staggered. When a first electronic signature is provided on a first contract during a first duration of time, then a second duration of time may be adjusted to be empty, thereby preventing a second electronic signature from being provided on a second contract. In this way, the sender may be protected from entering more contracts than is desired.

In at least one embodiment, the delay between when signatures are allowed may be utilized, for instance, to rate limit signups, boilerplate agreements, standard end user agreements, and so on. Any of a variety of documents with matching or substantially similar content may be utilized. For example, a sender may have a standard end user agreement that is sent to a relatively large number of customers, such as 200 customers. In this example, the sender may use the delays between signatures to control an incoming amount or flow of signed agreements, such as twenty per hour, fifty per day, and so on. In this way, the sender can limit the amount of incoming signed agreements to be processed to a manageable rate. Continuing with this example, a notification may be sent to a subsequent customer to inform the subsequent customer when the next electronic signature may commence.

The electronic signature from the second entity is requested responsive to occurrence of one or more events (block 606). Any suitable event may be utilized. For example, an event may include receipt of the first electronic signature. Another event may be when the predefined time elapses. Still another event may include a modification to the predefined time, such as a change to the date, hour, minute, or combination thereof. In at least one embodiment, the first entity may be given a week to provide an electronic signature. If the first entity provides the electronic signature prior to expiration of the week, the document manager module 118 may automatically initiate the request for the subsequent electronic signature from the second entity, without waiting for the remaining portion of the week to elapse, thereby accelerating the signing process. Thus, a variety of different events can be utilized to initiate the request for the subsequent electronic signature from the second entity.

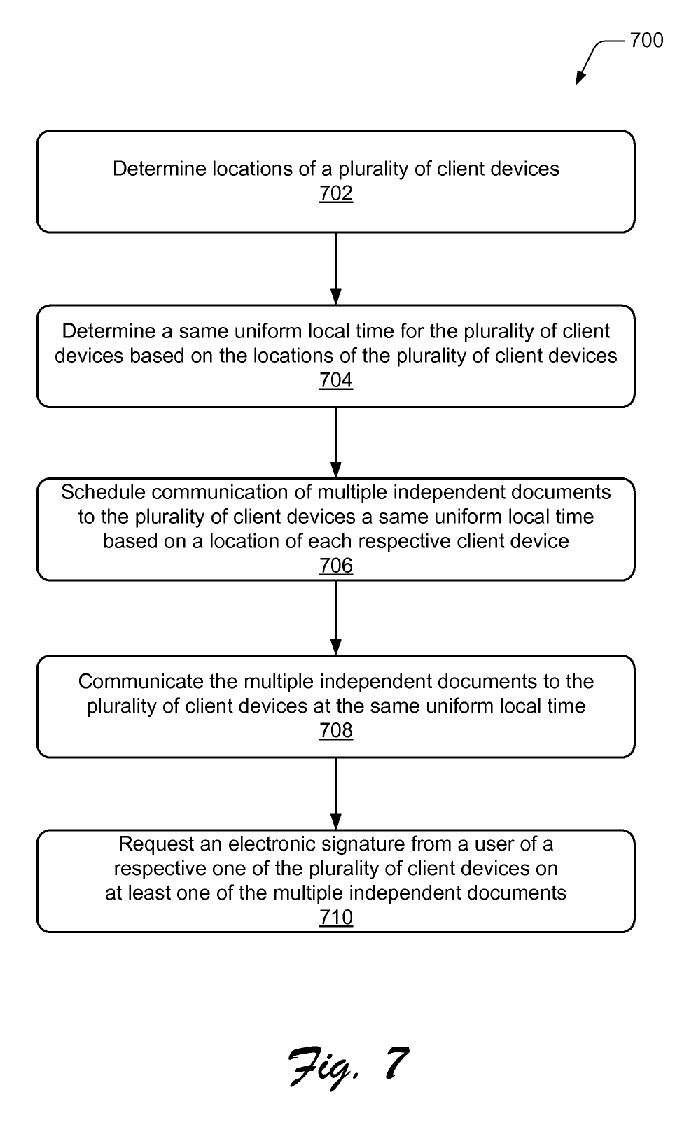

FIG. 7 is a flow diagram depicting a procedure 700 in an example implementation in which deferred delivery of electronically signed agreements are employed for multiple independent documents. Locations of a plurality of client devices are determined (block 702). Any suitable technique may be utilized to determine locations of client devices. For example, GPS, or other location services may be utilized to determine a physical location of one or more of the client devices. In another example, the service provider 106 may request from one or more of the client devices an indication of a current time zone in which the client device is located.

The locations of the client devices are used to determine a same uniform local time for the plurality of client devices (block 704). For example, different client devices may be located in different time zones, which could potentially result in one or more client devices receiving a document outside of business hours, or receiving the document prior to, or subsequent to, another of the client devices.

Multiple independent documents are scheduled for communication to the plurality of client devices at the same uniform local time based on a location of each respective client device (block 706). For instance, a document may be scheduled for communication to a client device located in Los Angeles, Calif. at 3:00 pm PST, whereas another document may be scheduled for communication to another client device located in New York City, N.Y. at 3:00 pm EST. In this way, a sender can schedule communication of the documents to the client devices according to each respective client device's corresponding time zone.

The multiple independent documents are communicated to the plurality of client devices at the same uniform local time (block 708). Based on the scheduling of the communication, the client devices may each receive a document at the same uniform local time. For instance, continuing with the above example, the client device located in Los Angeles, Calif. may receive the document at 3:00 pm PST, whereas the other client device located in New York City, N.Y. may receive the other document at 3:00 pm EST. In this way, each of the client devices may receive a document during respective local business hours, which may make the incoming document or notification of the document more visible in a user's inbox. For example, a user of the client device in New York may receive the other document during local business hours, rather than waiting until 6:00 pm EST, which is equivalent to the 3:00 pm PST when the client device in Los Angeles may receive the document. In this example, receiving the other document at 6:00 pm EST may not be during local business hours for the user in New York.

An electronic signature is requested from a user of a respective one of the plurality of client devices on at least one of the multiple independent documents (block 710). The electronic signature can be requested in any suitable way, such as those described above.

Example System and Device

FIG. 8 illustrates an example system generally at 800 that includes an example computing device 802 that is representative of one or more computing systems and/or devices that may implement the various techniques described herein. This is illustrated through inclusion of signature manager module 112, which may be configured to enable a user to electronically sign a document on the computing device 802. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

Cloud 814 includes and/or is representative of a platform 816 for resources 818. Platform 816 abstracts underlying functionality of hardware (e.g., servers) and software resources of the cloud 814. Resources 818 may include applications and/or data that can be utilized while computer processing is executed on servers that are remote from the computing device 802. Resources 818 can also include services 820 provided over the Internet and/or through a subscriber network, such as a cellular or Wi-Fi network.

Platform 816 may abstract resources and functions to connect computing device 802 with other computing devices. Platform 816 may also serve to abstract scaling of resources to provide a corresponding level of scale to encountered demand for resources 818 that are implemented via platform 816. Accordingly, in an interconnected device embodiment, implementation of functionality described herein may be distributed throughout system 800. For example, the functionality may be implemented in part on computing device 802 as well as via platform 816 that abstracts the functionality of cloud 814.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving a request for a user of a client device to provide an electronic signature on a document;
delaying access to at least a portion of content in the document by the user of the client device until a predefined time;
communicating at least the portion of the document to the client device at the predefined time; and
allowing the user of the client device to provide the electronic signature on the document at or after the predefined time.

2. The method as recited in claim 1, wherein the document comprises a contract between the user and at least one additional user.

3. The method as recited in claim 1, further comprising:
communicating at least the portion of the document to the client device before the predefined time; and
allowing the user to electronically sign the document only after the predefined time has passed.

4. The method as recited in claim 1, wherein the document comprises an agreement between multiple parties, the method further comprising:
revealing an existence of, and the multiple parties to, the agreement prior to the predefined time; and
preventing the multiple parties from reading one or more terms of the agreement or electronically signing the agreement until the predefined time.

5. The method as recited in claim 1, further comprising:
requesting the electronic signature from a first entity;
preventing a subsequent electronic signature from a second entity until the electronic signature from the first entity is received; and
requesting the subsequent electronic signature from the second entity responsive to receiving the electronic signature from the first entity.

6. The method as recited in claim 1, wherein the request includes:
a request for multiple different entities to provide respective electronic signatures on the document; and
an indication of one or more time intervals for each said entity to electronically sign the document.

7. The method as recited in claim 1, further comprising:
receiving a subsequent request to communicate one or more additional documents that include content matching the content in the document, the subsequent request specifying a time delay between when respective electronic signatures are allowed on the one or more additional documents.

8. The method as recited in claim 1, further comprising:
receiving a subsequent request to communicate, to one or more additional client devices, one or more additional documents that include content matching the content in the document; and
scheduling communication of the document and the one or more additional documents for a same uniform local time of each respective client device based on a location of each respective client device.

9. A computing device comprising:
a memory configured to maintain a document;
a processor to implement a document manager module that is configured to:
receive a request for an electronic signature on a document;
initiate communication of the document to a client device for user access to provide the electronic signature;
delay access to at least a portion of content in the document until a predefined time; and
allow the user of the client device to provide the electronic signature on the document at or after the predefined time.

10. The computing device as recited in claim 9, wherein the document comprises a contract between the user and at least one additional user.

11. The computing device as recited in claim 9, wherein the document manager module is configured to allow the user to electronically sign the document only after the predefined time has passed.

12. The computing device as recited in claim 9, wherein the document comprises an agreement between multiple parties, the document manager module configured to:
reveal an existence of, and the multiple parties to, the agreement prior to the predefined time; and
prevent the multiple parties from reading one or more terms of the agreement or electronically signing the agreement until the predefined time.

13. The computing device as recited in claim 9, wherein the document manager module is configured to:
request the electronic signature from a first entity;
prevent a subsequent electronic signature from a second entity until the electronic signature from the first entity is received; and
request the subsequent electronic signature from the second entity responsive to receiving the electronic signature from the first entity.

14. The computing device as recited in claim 9, wherein the request includes:
a request for multiple different entities to provide respective electronic signatures on the document; and
an indication of one or more time intervals for each said entity to electronically sign the document.

15. The computing device as recited in claim 9, wherein the document manager module is configured to:
receive a subsequent request to communicate one or more additional documents that include content matching the content in the document, the subsequent request specifying a time delay between when respective electronic signatures are allowed on the one or more additional documents.

16. The computing device as recited in claim 9, wherein the document manager module is configured to:
receive a subsequent request to communicate, to one or more additional client devices, one or more additional documents that include content matching the content in the document; and
schedule communication of the document and the one or more additional documents for a same uniform local time of each respective client device based on a location of each respective client device.

17. A computer-readable storage memory storing instructions that, responsive to execution by a computing device, cause the computing device to perform operations comprising:
receiving a request for a user of a client device to provide an electronic signature on a document;
delaying access to at least a portion of content in the document by the user of the client device until a predefined time;
communicating at least the portion of the document to the client device; and
allowing the user of the client device to provide the electronic signature on the document at or after the predefined time.

18. The computer-readable storage memory as recited in claim 17, wherein the operations further comprise, allowing the user to electronically sign the document only after the predefined time has passed.

19. The computer-readable storage memory as recited in claim 17, wherein the document comprises an agreement between multiple parties, the operations further comprising:
revealing an existence of, and the multiple parties to, the agreement prior to the predefined time; and
preventing the multiple parties from reading one or more terms of the agreement or electronically signing the agreement until the predefined time.

20. The computer-readable storage memory as recited in claim 17, wherein the operations further comprise:
requesting the electronic signature from a first entity;
preventing a subsequent electronic signature from a second entity until the electronic signature from the first entity is received; and
requesting the subsequent electronic signature from the second entity responsive to occurrence of one or more events.
